(19) United States
(12) Patent Application Publication
(10) Pub. No.: US 2021/0304083 A1
(43) Pub. Date: Sep. 30, 2021

(54) COMPUTER-BASED AUTOMATED ACQUISITION SYSTEM

(71) Applicant: UFlip, LLC, Moore, OK (US)

(72) Inventors: Michael Fletcher, Moore, OK (US); Kevin Golob, Moore, OK (US); Christen Meier, Oklahoma City, OK (US)

(21) Appl. No.: 17/229,519

(22) Filed: Apr. 13, 2021

Related U.S. Application Data
(63) Continuation of application No. 16/294,389, filed on Mar. 6, 2019, now abandoned.
(60) Provisional application No. 62/639,070, filed on Mar. 6, 2018.

(51) Int. Cl. G06Q 10/02; G06Q 30/06

(52) U.S. Cl. CPC G06Q 10/02; G06Q 10/0838; G06Q 30/0637

(57) ABSTRACT

An automated system having a processor is described. In one embodiment, the processor executing an acquisition software application receiving: at least one buy request from a flipper system, the buy request associated with at least one ticket for an event from a ticket sales and distribution system; and, at least one of a confirmation number and e-mail address associated with buy request and the ticket sales and distribution system; wherein the acquisition software application approves the at least one buy request and uses the at least one of the confirmation number and e-mail address to access the ticket sales and distribution system and obtain the at least one ticket for the event.

### CROSS REFERENCE TO RELATED APPLICATION/INCORPORATION BY REFERENCE

The present patent application is a continuation off of U.S. Ser. No. 16/294,389, filed Mar. 6, 2019, which claims priority to the provisional patent application identified by U.S. Ser. No. 62/639,070, filed on Mar. 6, 2018, the entire contents of each of which are hereby expressly incorporated by reference herein.

### BACKGROUND

Currently, systems for acquisition of tickets within the entertainment industry and other industries are problematic in that tickets are provided in an under-priced market that rewards speed of purchase of the tickets. Such systems generally reward traders capable of buying large amounts of tickets at a fast speed with the intent to re-sell such tickets at a higher cost. Software systems, such as ticket bots, have been used to compete with individual consumers when tickets go on sale. Ticket bots are computer programs that are used to quickly buy tickets so that the tickets may be resold elsewhere for more money than the original purchase price. Generally, ticket bots automate the process of buying a ticket such that in a matter of milliseconds, the ticket bots software is able to acquire thousands of tickets from different IP addresses, which gives the ticket bots systems an advantage over human ticket buyers.

In order to limit such high-speed large transactions, in 2016 the Better Online Ticket Sales (BOTS) Act was passed to limit the use of computer software that enables ticket bots. Additionally, ticket sales and distribution companies, such as Ticketmaster, generally now require a security measure, access control system, or other technological measure on an Internet website or online service in order to process tickets and/or enforce ticket purchasing limits and the like, in order to limit the use of automated ticket acquisition software programs and systems.

The problem of creating software systems, such as ticket bots, that can work around such measures in a legal manner has become increasingly more difficult as each individual ticket sales and distribution system may have an individualized system requiring specific consumer feedback in order to process tickets. For example, many ticket sales and distribution systems require each individualized user to recognize a code, photograph, or the like, and parrot, restate, or reiterate such information to gain access to the tickets.

In addition, Ticketmaster, for example, has initiated a system designed to limit automated ticket bots software using a “Verified Fan” program software. Generally, the Verified Fan program software requires a purchaser to pre-register with a Ticketmaster account and request to be included in a ticket sale ahead of the time the sale begins. Using an algorithm, the Verified Fan program software may determine the identity and level of fandom of each purchaser requesting a ticket. If approved, the purchaser receives a text message with a verification code (which is an additional step meant to verify that the purchaser is a real person and not a software program), and an invitation to buy tickets just before they go on sale. As such, Ticketmaster's computer software system requires the use of a human counterpart in order to process tickets. As a result, prior art automated software methods designed to subvert the ticket sales and distribution systems to obtain tickets no longer work effectively.

However, despite the impediments put in place by ticket sources, ticket resale is a standard part of ticket sales systems and such services are often desired by fans to secure better seats without the hassle of acquiring the tickets from the original source. Some economists endorse secondary markets of this type as a true indicator of supply and demand. As ticket sales and distribution systems work to shut down automated systems through technological means, there becomes a need for a specific implementation of a technological solution to this software problem in the form of systems and methods that allow for ticket acquisition legally and provide consumers with a secondary market of convenience through technological advancement.

### BRIEF DESCRIPTION OF THE DRAWINGS

These and other objects and features of the present invention will be more fully disclosed or rendered obvious by the following detailed description of the invention, which is to be considered together with the accompanying drawings wherein like numbers refer to like parts, and further wherein:

FIG. 1 illustrates a block diagram of an exemplary acquisition system in accordance with the present disclosure, configured to facilitate buying and selling of fare(s), admission(s), and/or entitlement(s) to some service, right, and/or the like.

FIG. 2 illustrates a block diagram of an exemplary profile application of an acquisition software application in accordance with the present disclosure.

FIGS. 3-6 illustrate screen shots of exemplary pages in a profile application for use on a flipper system.

FIG. 7 illustrates a block diagram of exemplary events application of an acquisition software application in accordance with the present disclosure.

FIGS. 8-10 illustrate screen shots of exemplary pages in an event application for use on a flipper system.

FIG. 11 illustrates a My Request application of an acquisition software application in accordance with the present disclosure.

FIGS. 12-14 illustrate screen shots of exemplary pages in a My Request application for use on a flipper system.

FIG. 15 illustrates an inventory application of an acquisition software application in accordance with the present disclosure.

FIG. 16 illustrates a screen shot of an exemplary page in an inventory application for use on a flipper system.

FIG. 17 illustrates an accounts receivable application of an acquisition software application in accordance with the present disclosure.

FIG. 18 illustrates a screen shot of an exemplary page in an accounts receivable application for use on a flipper system.

FIG. 19 illustrates an acquisition software application for a flood system in accordance with the present disclosure.

FIG. 20 illustrates a screen shot of an exemplary page in an acquisition software application for a flood system.

### DETAILED DESCRIPTION OF EXEMPLARY EMBODIMENTS

Before explaining at least one embodiment of the presently disclosed and claimed inventive concepts in detail, it is to be understood that the presently disclosed and claimed inventive concepts are not limited in their application to the details of construction, experiments, exemplary data, and/or the arrangement of the components set forth in the following description or illustrated in the drawings. The presently disclosed and claimed inventive concepts are capable of other embodiments or of being practiced or carried out in various ways. Also, it is to be understood that the phraseology and terminology employed herein is for purpose of description and should not be regarded as limiting.

The mechanisms proposed in this disclosure overcome the problems in the software arts associated with legally obtaining tickets for resale. The present disclosure describes an acquisition system that is a technology and communication platform which, in some embodiments, has a primary function to acquire tickets from box office websites like Ticketmaster.com and AXS.com. The acquisition system enables ticket brokers/resellers (buyers) to communicate lists of events that they are interested in buying tickets for to verified individuals that are referred to herein as flippers. These flippers are provided with flipper systems that assist the flippers in attempting to procure tickets on behalf of the buyers by visiting the box office website and, at first, putting the ticket in the flipper's shopping cart. Next the flippers enter the seat location and cost of the seats in their flipper systems, which communicate the seat location and costs to flood systems (which also may be known as a ticket feed system) operated by the buyers so that the buyers can make their buying decision. Through the use of the flood system, the presently described acquisition system provides the buyers with automated tools that permit the buyers to either reject the tickets submitted by the flippers or send over an authorization to purchase. If the tickets are authorized to be purchased, the flipper proceeds with the checkout and confirms the purchase details to the buyers through the acquisition system. If the acquisition system indicates that the tickets are rejected, the flipper may release the tickets from their shopping cart to avoid completing the checkout.

The acquisition system enables and manages all of the communication between the buyers and the flippers. The acquisition system tracks all purchases and manages all buying activities for both buyers and flippers. The acquisition system also provides the interface for buyers and flippers to exchange real time ticket information that aids in the purchasing of tickets from box office websites. The acquisition system provides the reporting used for ticket inventory management, accounts payable, auditing, and dispute resolution. The acquisition system also provides the real time event information to flippers. Lastly, the acquisition system is used to confirm purchase information between buyer point of sale systems to ensure accuracy and accountability of all tickets purchased.

By communicating the buyer's desire to acquire tickets to a variety of flippers who can legally obtain and resale the tickets, the acquisition system permits the buyers to obtain a sufficient inventory of tickets to establish a secondary market, while avoiding the use of ineffective automated bots. This is accomplished by the practical application of the exemplary technology that is described hereinafter. Also, while the present acquisition system is described by way of example for obtaining tickets, it should be understood that the acquisition system can be used to obtain other goods or services as described hereinafter.

In the following detailed description of embodiments of the inventive concepts, numerous specific details are set forth in order to provide a more thorough understanding of the inventive concepts. However, it will be apparent to one of ordinary skill in the art that the inventive concepts within the disclosure may be practiced without these specific details. In other instances, certain well-known features may not be described in detail in order to avoid unnecessarily complicating the instant disclosure.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherently present therein.

Unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

The term “and combinations thereof” as used herein refers to all permutations or combinations of the listed items preceding the term. For example, “A, B, C, and combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. A person of ordinary skill in the art will understand that typically there is no limit on the number of items or terms in any combination, unless otherwise apparent from the context.

In addition, use of the “a” or “an” are employed to describe elements and components of the embodiments herein. This is done merely for convenience and to give a general sense of the inventive concepts. This description should be read to include one or at least one and the singular also includes the plural unless it is obvious that it is meant otherwise.

The use of the terms “at least one” and “one or more” will be understood to include one as well as any quantity more than one, including but not limited to each of, 2, 3, 4, 5, 10, 15, 20, 30, 40, 50, 100, and all integers and fractions, if applicable, therebetween. The terms “at least one” and “one or more” may extend up to 100 or 1000 or more, depending on the term to which it is attached; in addition, the quantities of 100/1000 are not to be considered limiting, as higher limits may also produce satisfactory results.

The term “flipper”, as used herein, refers to a person who purchases or otherwise acquires rights and may provide the rights to a third party.

Further, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein qualifiers such as “about,” “approximately,” and “substantially” are intended to signify that the item being qualified is not limited to the exact value specified, but includes some slight variations or deviations therefrom, caused by measuring error, manufacturing tolerances, stress exerted on various parts, wear and tear, and combinations thereof, for example.

Software may include one or more computer readable instructions that when executed by one or more components cause the component to perform a specified function. It should be understood that algorithms or process instructions described herein may be stored on one or more non-transitory computer readable medium. Exemplary non-transitory computer readable medium may include random access memory, read only memory, flash memory, and/or the like. Such non-transitory computer readable mediums may be electrically based, optically based, and/or the like.

Circuitry, as used herein, may be analog and/or digital components, or one or more suitably programmed processors (e.g., microprocessors) and associated hardware and software, or hardwired logic. Also, “components” may perform one or more functions. The term “component,” may include hardware, such as a processor (e.g., microprocessor), an application specific integrated circuit (ASIC), field programmable gate array (FPGA), a combination of hardware and software, and/or the like. The term “processor” as used herein means a single processor or multiple processors working independently or together to collectively perform a task.

Certain exemplary embodiments of the invention will now be described with reference to the drawings.

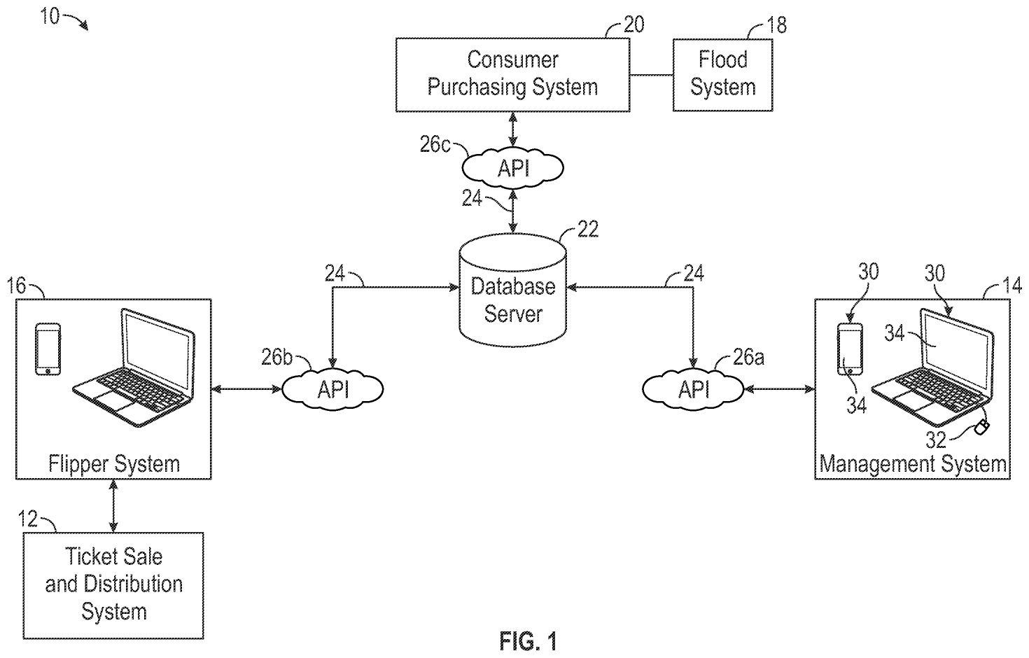

Referring to the Figures, and in particular FIG. 1, shown therein is a block diagram of an exemplary acquisition system 10 configured to facilitate buying and selling of fare(s), admission(s), and/or entitlement(s) to some service, right, and/or the like. For example, in some embodiments, the acquisition system 10 may be configured to facilitate the buying and selling of tickets for an entertainment event (e.g., concert, sports, arts, theatre and/or other entertainment event). In some embodiments, the acquisition system 10 may be configured to facilitate buying and selling of property such as, for example, sneakers, electronics, collectibles, and/or the like. Other uses are contemplated for facilitation of buying and selling of fare(s), admission(s), and/or entitlement(s) to some service, right, and/or the like. For simplicity of description, the following detailed description of exemplary embodiments will describe facilitation of buying and selling of tickets for an entertainment event. This description, however, does not limit the use of the acquisition system 10 to solely tickets for an entertainment event as other uses are contemplated wherein facilitation of buying and selling of fare(s), admission(s), and/or entitlement(s) to some service, right, and/or the like may be provided in accordance with the present disclosure.

Referring to FIG. 1, generally ticket sales and distribution systems 12 may provide a security measure, access control system, or other technological measure on an Internet website or online service in order to process tickets and/or enforce ticket purchasing limits and the like. Such measures rely on human interaction and personal data to limit ticket bots known within the industry. The acquisition system 10 may include one or more management systems 14 configured to oversee one or more flipper systems 16 operated by a user. User interaction with the ticket sales and distribution systems 12 may allow for sequential reservation and/or purchase of tickets using multiple simultaneous connections, human interaction and personal data.

Generally, the management system 14 may provide a desired ticket request for an event to the one or more flipper systems 16. The user of each flipper system 16 may access the ticket sales and distribution system 12 to reserve one or more tickets to the event using human interaction. Such human interaction may aid in meeting the requirements of software security measures for acquiring tickets of the ticket sales and distribution system 12. Upon reservation of the tickets by the flipper system 16 via the ticket sales and distribution system 12 (and in some embodiments maintaining communications with the ticket sales and distribution system 12), the flipper system 16 may transmit a buy request to the one or more flood systems 18 having details of the reserved ticket(s). For example, the buy request may indicate at least one of a purchase price and a location for each ticket for the event. The flood system 18 may approve or pass on the buy request based on the ticket request of the management system 14 during a period in time in which the flipper system 16 is maintaining communication and has an open ticket reservation with the ticket sales and distribution system, and transmit one or more communication to the flipper system 16 to purchase or acquire the one or more tickets and/or pass on the one or more tickets. In some embodiments, approval or passing of the buy request by the flood system 18 may be automatic (i.e., without human interaction). Based on the outcome of the buy request, the user of the flipper system 16 may acquire the one or more tickets and/or pass on the one or more tickets and send one or more communications to the management system 14 and/or flood system 18. In some embodiments, the acquisition system 10 may also include a consumer purchasing system 20 configured to provide consumers with information indicative of one or more tickets for purchase. The tickets are obtained via approved buy requests from the flood system 18.

The acquisition system 10 may be a system or systems that are able to embody and/or execute the logic of the processes described herein. Logic embodied in the form of software instructions and/or firmware may be executed on computer hardware. For example, logic embodied in the form of software instructions or firmware may be executed on a dedicated system or systems, a distributed system, and/or the like. In some embodiments, logic may be implemented in a stand-alone environment operating on a single processor and/or logic may be implemented in a networked environment, such as a distributed system using multiple computers and/or processors.

The acquisition system 10 as shown in FIG. 1 illustrates the acquisition system 10 having a database server 22. It should be noted that a single server or additional servers may be included. In some embodiments, the database server 22 may be network-based, cloud based, and any variations thereof, may include the provision of configurable computational resourced on demand via interfacing with a computer and/or computer network, with software and/or data at least partially located on the computer and/or computer network, by pooling processing power of two or more networked processors.

The database server 22 may be capable of interfacing and/or communicating with the management system 14, flipper system 16, consumer purchasing system 20, and/or flood system 18 via a network 24. For example, the network 24 may interface by optical and/or electronic interfaces, and/or may use a plurality of network topographies and/or protocols including, but not limited to, Ethernet, TCP/IP, circuit switched paths, and/or combinations thereof. For example, in some embodiments, the network 24 may be implemented as the World Wide Web (or Internet), a local area network (LAN), a wide area network (WAN), a metropolitan network, a wireless network, a cellular network, a Global System for Mobile Communications (GSM) network, a code division multiple access (CDMA) network, a 3G network, a 4G network, a satellite network, a radio network, an optical network, a cable network, a public switched telephone network, an Ethernet network, combinations thereof, and/or the like. Additionally, the network 24 may use a variety of network protocols to permit bi-directional interface and/or communication of data and/or information. It is conceivable that in the near future, embodiments of the present disclosure may use more advanced networking topologies.

In some embodiments, the network 24 may be the Internet and/or other network. For example, if the network 24 is the Internet, a primary user interface of the flipper system 16 may be delivered through a series of web pages. It should be noted that the primary user interface of the flipper system 16 may be replaced by another type of interface, such as, for example, a Windows-based application. Additionally, a primary user interface of the management system 14 and/or the flood system 18, and consumer purchasing system 20 may be delivered through a series of web pages or replaced by another type of interface, such as, for example, a Windows-based application, a smartphone application, or a tablet application.

The database server 22 may be capable of reading and/or executing processor executable code and/or capable of creating, manipulating, retrieving, altering, and/or storing data structures into one or more memories. The one or more memories may be capable of storing processor executable code. Additionally, the one or more memories may be implemented as a conventional non-transitory memory, such as, for example, random access memory (RAM), a CD-ROM, a hard drive, a solid state drive, a flash drive, a memory card, a DVD-ROM, a floppy disk, an optical drive, combinations thereof, and/or the like, for example.

In some embodiments, the one or more memories may be located in the same physical location. Alternatively, one or more memories may be located in a different location as the database server 22 and communicating via a network, such as the network 24. Additionally, one or more of the memories may be implemented as a “cloud memory” (i.e., one or more memories may be partially or completely based on or accessed using a network, such as network 24, for example).

The one or more memories may store processor executable code and/or information comprising one or more databases and program logic. In some embodiments, the processor executable code may be stored as a data structure, such as a part of database and/or datatable, for example. In some embodiments, one of the databases may be a flipper database storing identifying characteristics retrieved and/or determined from one or more users for the flipper system 16. In some embodiments, one of the databases may be a flipper communication database storing one or more communications received from the flipper system 16. In some embodiments, one of the databases may be an event database storing one or more identifying characteristics retrieved from the ticket sale and distribution system 12 and/or relating to one or more entertainment events. The entertainment events can be added by event broker(s) or fan(s). In some embodiments, one of the databases may be a flood communication database, storing one or more flood communications received from the flood system 18. In some embodiments, one of the databases may be a management communication database, storing one or more communication received from the management system 14. In some embodiments, one of the databases may be a passed communication database, storing one or more passed buy request communications. In some embodiments, one of the databases may be a consumer purchasing system database, storing one or more consumer purchasing communications. In some embodiments, one of the databases may be an approved communication database, storing one or more approved buy request communications.

In some embodiments, the database server 22 may communicate with the management system 14, flipper system 16, flood system 18, and/or consumer purchasing system 20 via application programming interfaces APIs 26a, 26b, and 26c respectfully (e.g., representational state transfer (Restful Service) API). To that end, each API 26a, 26b and 26c may communicate with database server 22. It should be noted that the database server 22 may communicate with the management system 14, flipper system 16, flood system 18 and/or consumer purchasing system 20 via other methods including, but not limited to, JSON, SOAP, or XML, direct communication, and/or the like.

The management system 14 may include one or more processors 30 configured to communicate with the database server 22. The one or more processors 30 may work together, or independently to execute processor executable code. Additionally, the management system 14 may include one or more memories capable of storing processor executable code. In some embodiments, each element of the management system 14 may be partially or completely network-based or cloud-based, and may or may not be located in a single physical location.

The one or more processors 30 may be implemented as a single or plurality of processors working together, or independently, to execute the logic as described herein. Exemplary embodiments of the one or more processors 30 may include, but are not limited to, a digital signal processor (DSP), a central processing unit (CPU), a field programmable gate array (FPGA), a microprocessor, a multi-core processor, and/or combinations thereof, for example. The one or more processors may be capable of communicating via the network 24 or a separate network (e.g., analog, digital, optical, and/or the like) via one or more ports (e.g., physical or virtual ports) using a network protocol. The one or more processors 30 may be capable of reading and/or executing processor executable code and/or capable of creating, manipulating, retrieving, altering, and/or storing data structure into one or more memories.

In some embodiments, the one or more memories may be located in the same physical location as one or more processors 30. Alternatively, the one or more memories may be implemented as a “cloud memory” (i.e., one or more memories may be partially or completely based on or accessed using a network, for example).

The one or more memories may store processor executable code and/or information comprising one or more databases and program logic. For example, the database hosted by the management system 14 may store data indicative of an inventory of users (e.g., flippers) accessing the database server 22, activities the users have initiated, completed, or have access to, data indicative of an amount of funds allocated to a particular activity (e.g., event or ticket), and/or data indicative of monetary funds accrued by the user for completion of an activity. In some embodiments, such information may be accessed by the management system 14 via the database server 22. To that end, the management system 14 may access data (e.g., fund accrued by the user) stored in one or more memories in the database server 22 via a series of web pages, for example.

In some embodiments, the management system 14 may include one or more input devices 32 and one or more output devices 34. The one or more input devices 32 may be capable of receiving information directly from a user, processor, and/or environment, and transmit such information to the one or more processors 30 and/or the network 24. The one or more input devices 32 may include, but are not limited to, implementation as a keyboard, touchscreen, mouse, trackball, microphone, fingerprint reader, infrared port, cell phone, PDA, controller, network interface, speech recognition, gesture recognition, eye tracking, brain-computer interface, combinations thereof, and/or the like.

The one or more output devices 34 may be capable of outputting information in a form perceivable by a user and/or processor(s). In some embodiments, the one or more output devices 34 may be configured to output information automatically (i.e., without human intervention). For example, in some embodiments, the one or more output devices 34 may be capable of printing or displaying at a pre-determined time interval an accounting of users (i.e., flippers), monetary funds accrued by such users, ticket inventory, and/or the like. The one or more output devices 34 may include, but are not limited to, implementation as a computer monitor, a screen, a touchscreen, a speaker, a website, a television set, an augmented reality system, a smart phone, a PDA, a cell phone, a fax machine, a printer, a laptop computer, an optical head-mounted display (OHMD), combinations thereof, and/or the like.

The management system 14 may communicate with the database server 22 using any communication protocol (e.g., SOAP, XML, JSON, REST). In some embodiments, the database server 22 may serve as the intermediary between all system elements, (e.g., management system 14, flipper system 16, flood system 18, and/or consumer purchasing system 20). In some embodiments, the management system 14 may communicate directly with at least one of the flipper system 16, the flood system 18, and the consumer purchasing system 20.

The management system 14 may store processor executable instructions or a software application. For example, the management system 14 may include a web browser and/or a native software application running on the management system 14 and configured to communicate with the database server 22 over the network 24. The software application on the management system 14 may be configured of accessing a website and/or communicating information and/or data with the database server 22 over the network 24.

In some embodiments, the management system 14 may include an application program (e.g., specialized program downloaded onto the management system 14), and communicate with the database server 22 via the network 24 through the application. In some embodiments, the network 24 may be the Internet and/or other network. For example, if the network 24 is the Internet, a primary user interface of acquisition platform software may be delivered through a series of web pages.

The management system 14 may be provided with one or more actions during communication with the database server 22. To that end, the management system 14 may be configured to alter one or more databases within the database server 22, transmit one or more communications to the database server 22, receive one or more communication from the database server 22, provide an event profile, update an event profile, view real time statistics (e.g., allocation of monetary funds, inventory of tickets, inventory of events), provide an account profile for a flipper, update an account profile for a flipper, register one or more events, set-up one or more events for broker(s) and fan(s), manage flippers, provide fraud security features, payment processing, reporting, and notifications services.

The acquisition system 10 may include one or more flipper systems 16. The database server 22 may communicate with the flipper system 16 to transmit one or more ticket requests, receive one or more ticket requests, transmit one or more ticket approvals or passes, receive user characteristics, receive monetary valuations, and/or the like.

The flipper systems 16 may be implemented as a smartphone, a tablet, a laptop computer, a personal computer, a desktop computer, a computer terminal, a computer workstation, an e-book reader, a wireless network-capable handheld device, a personal digital assistant, a kiosk, a gaming system, and/or the like. Similar to the management system 14, the flipper system 16 may be provided with one or more processors, one or more non-transitory processor readable medium, an input device, and an output device. The processor, the one or more non-transitory processor readable medium, the input device, and the output device of the flipper system 16 may be implemented similarly to or the same as the processor 30, the input device 32, and the output device 34 respectively. The flipper system 16 may be configured to interface with the network 24, via a wired or wireless interface.

The flipper system 16 may store processor executable instructions or a software application. For example, the flipper system 16 may include a web browser and/or a native software application running on the flipper system 16 and configured to communicate with the database server 22 over the network 24. The software application on the flipper system 16 may be configured to access a website and/or communicate information and/or data with the database server 22 over the network 24.

In some embodiments, the flipper system 16 may include an application program (e.g., specialized program downloaded onto the flipper system 16), and communicate with the database server 22 via the network 24 through the application program. In some embodiments, the network 24 may be the Internet and/or other network. For example, if the network 24 is the Internet, a primary user interface of the acquisition platform software may be delivered through a series of web pages.

The flipper system 16 may be provided with one or more actions during communication with the database server 22. To that end, the flipper system 16 may be configured to alter one or more database(s) within the database server 22, transmit one or more communications to the database server 22, receive one or more communication(s) from the database server 22, provide a user profile, update an event profile with status of one or more tickets, view real time statistics (e.g., allocation of monetary funds, inventory of tickets, inventory of events), update an account profile for a user, and/or the like.

The acquisition system 10 may include one or more flood systems 18. Similar to the management system 14, the flood system 18 may be provided with one or more processors and one or more non-transitory processor readable medium. In some embodiments, the flood system 18 may also include an input device, and an output device similar to the management system 14. The processor, the one or more non-transitory processor readable medium, the input device, and the output device of the flood system 18 may be implemented similarly to or the same as the processor 30, the input device 32, and the output device 34 respectively. The flood system 18 may be configured to interface with the network 24, via a wired or wireless interface. In some embodiments, the flood system 18 may communicate via the database server 22 with the management system 14, the flipper system 16 and/or the consumer purchasing system 20. In some embodiments, the flood system 18 may communicate directly with at least one of the management system 14, the flipper system 16 and the consumer purchasing system 20.

The flood system 18 may be provided with one or more administrator actions during communication with the database server 22. To that end, the flood system 18 may be configured to approve and/or reject ticket requests transmitted via the database server 22 from the flipper system 16. Exemplary actions may include, but are not limited to, approve/reject buy requests; view flipper buy requests; update/change the amount of overs on a specific buy request; view seating chart(s) for the tickets submitted as a buy request; display market data for the tickets submitted as a buy request; view buy requests for tickets pulled by specific flippers; view buy requests for tickets pulled from specific marketplaces; show confirmed, expired, rejected, and pending buy requests; update/change the preferred delivery method used by the flipper for the marketplace purchase; alert when buy request is received from flipper; set specific ticket parameters to be shown on flood system; show pending buy count (working), confirmed buys (success), and rejected/expired pending buys (errors); and/or the like.

Generally, program logic of the acquisition system 10 as it relates to the buying and selling of tickets for an entertainment event, may oversee and manage ticket buying and selling for events and manage one or more users of the one or more flipper systems 16 capable of purchasing tickets from the one or more ticket sale and distribution systems 12. In some embodiments, program logic of the one or more flood systems 18 may include an automated process configured to approve or reject buy requests for reserved tickets obtained from the one or more flipper systems 16.

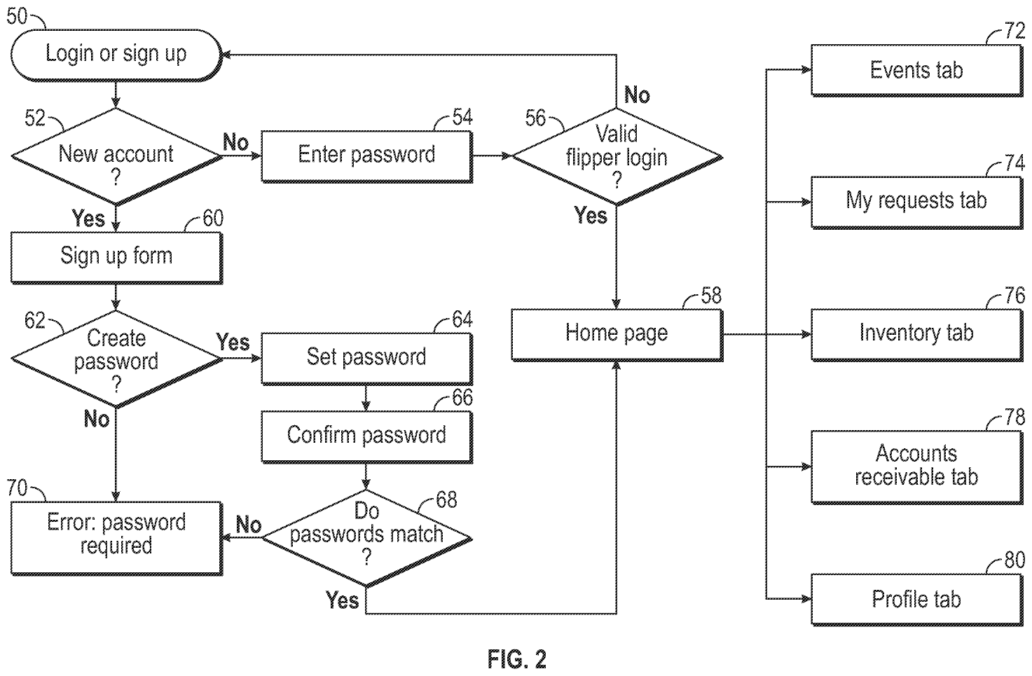

FIGS. 2-18 illustrate an exemplary embodiment of the acquisition software application for the flipper system 16 of the acquisition system 10. The acquisition software application for the flipper system 16 may be downloaded onto the one or more flipper system 16. Alternatively, the acquisition software application for the flipper system 16 may be accessed from the database server 22 via the network 24.

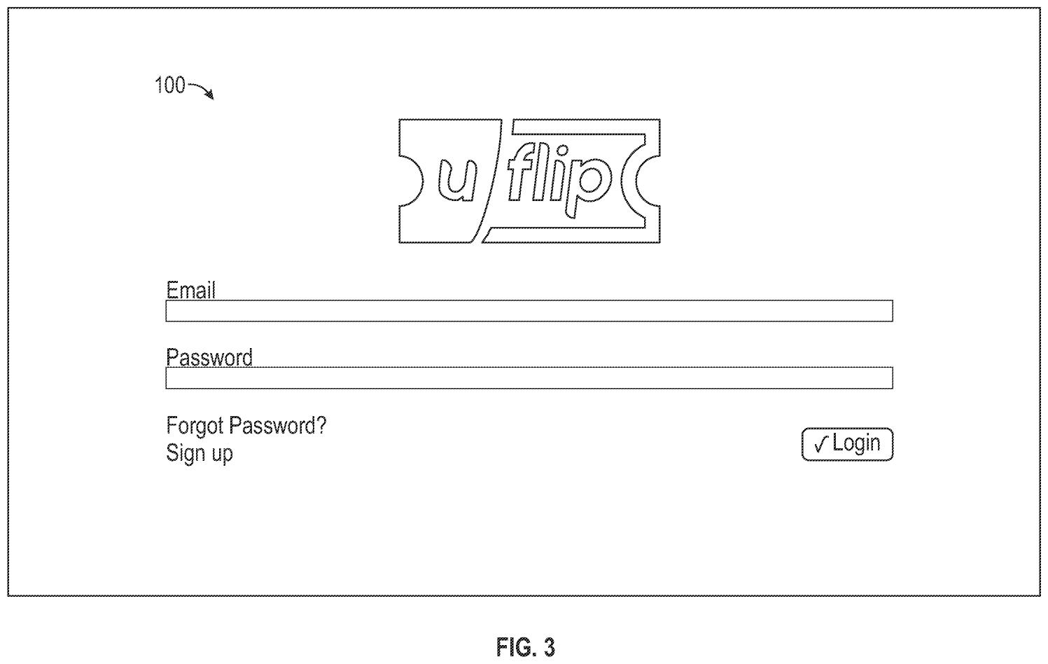

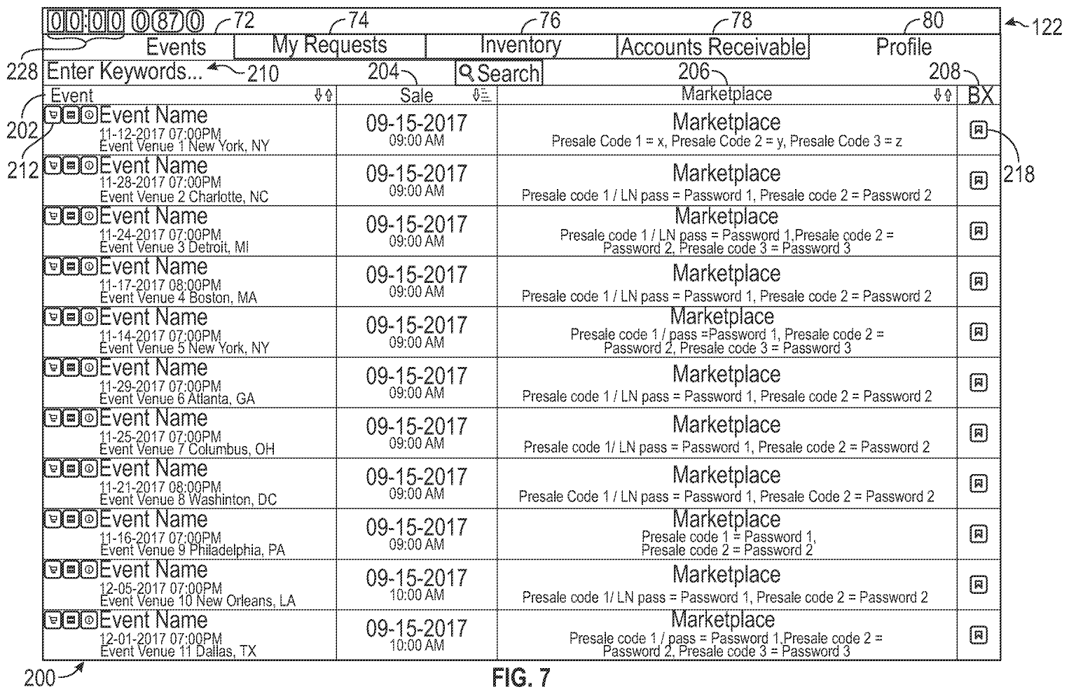

FIGS. 2-5 illustrate a set up and login process for a user of the flipper system 16. Generally, in a step 50, the flipper system 16 may query the user on whether the user has an account with the database server 22 as shown in FIG. 2 and an exemplary screen shot 100 in FIG. 3. In a step 52, the user may indicate, via the flipper system 16, whether the user has an account with the database server 22. If the user has an account with the database server 22, the user may enter a password in a step 54. In some embodiments, the password may be transmitted to the database server 22 and/or the management system 14 for confirmation on account status. Once account status is confirmed in a step 56, the user may be directed to a Home Page in a step 58 illustrated in FIG. 2 and the screen shot 102 shown in FIG. 7.

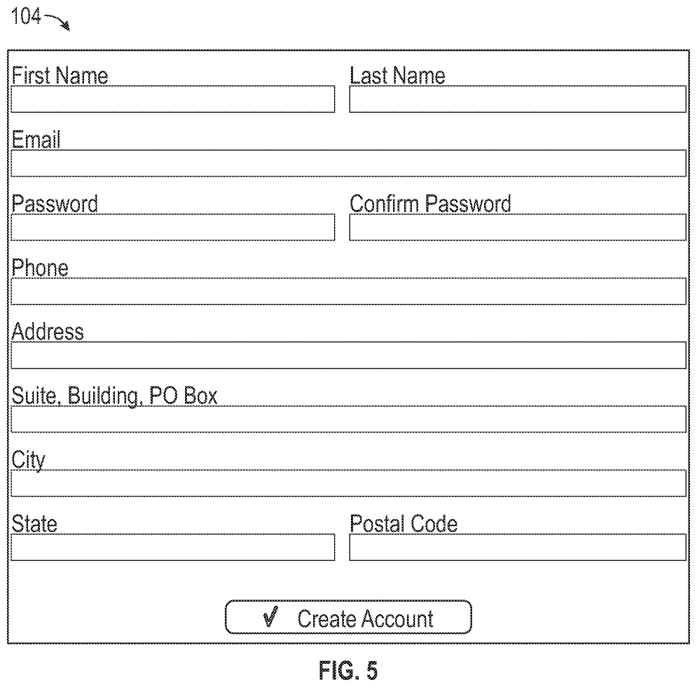

If the user is a new user (i.e., without a user account), the user may be directed to sign up a new account in a step 60 and shown in the screen shot 104 shown in FIG. 5. The sign-up form for the user may include identifying characteristics of the user including, but not limited to, name, e-mail address, phone number, physical address, identifying demographics, and/or the like. Additionally, the user may be directed in a step 62 to create a password. The password may be confirmed via a series of steps including, setting the password in a step 64, confirming the password in step 66, determining whether passwords match in a step 68, and providing error messages for incorrect passwords in a step 70. Once the user password is correct and a user account is set up for the user, the user may be directed to the Home Page in a step 58.

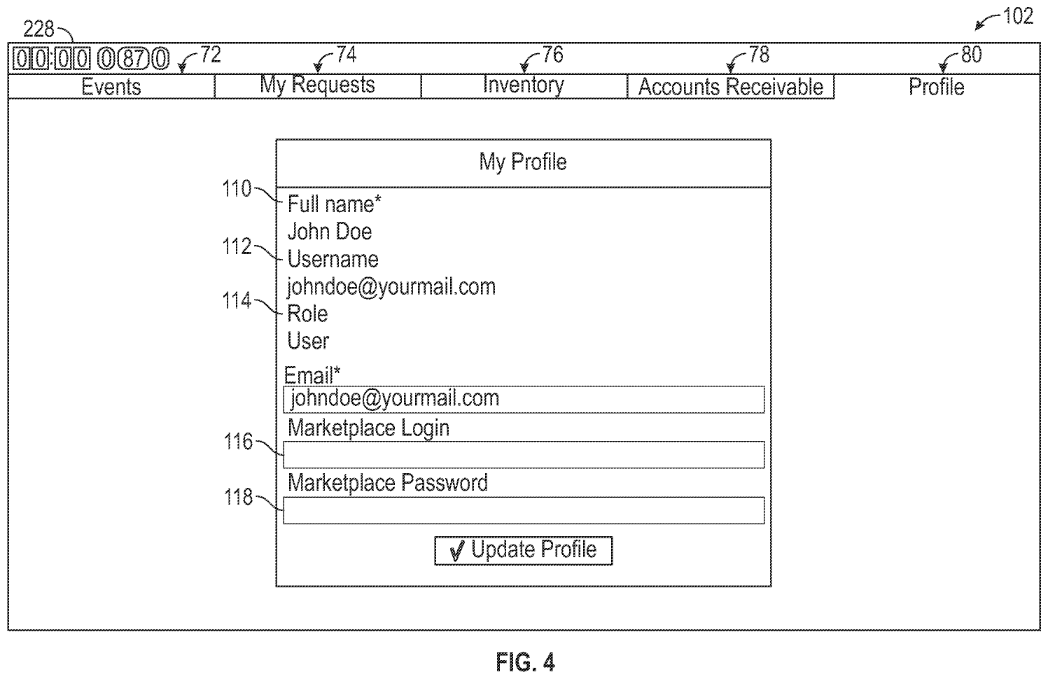

The acquisition software application for the flipper system 16 may include resources including, but not limited to, an events tab 72 associated with an events application, a My Requests tab 74 associated with a My Requests application, an inventory tab 76 associated with an inventory application, an accounts receivable tab 78 associated with an accounts receivable application, profile tab 80 associated with a profile application, and the like. The screen shot 102 of Home Page is shown in FIG. 4, and includes each of the events tab 72, My Requests tab 74, inventory tab 76, accounts receivable tab 78 and profile tab 80 which are herein described in further detail in accordance with the associated application of the acquisition software application.

The profile tab 80 may access the Profile Page. The Profile Page may include one or more identifying characteristics of the user including, but not limited to, name, username, role (e.g., user, manager), email address, physical address, identifying demographics, and/or the like. In some embodiments, the profile tab 80 may include username and/or password login information and/or queries for username and/or password login information for one or more ticket sales and distribution systems 12. To that end, the profile application may query the user for identifying characteristics as needed. For example, the screen shot 102 of the Profile page in FIG. 4 illustrates a name identifier 110, a username identifier 112, a role identifier 114, box office account credentials (i.e., credentials for ticket sales and distribution systems 12), e-mail account credentials tied to ticket sales and distribution systems 12, billing information, contact information, credit check of user, and/or the like. For example, in FIG. 4, the Profile page includes an identifier 116 for a ticket marketplace login and an identifier 118 for a ticket marketplace password. In some embodiments, identifying characteristics for the one or more ticket sales and distribution systems 12 may allow for the acquisition system 10 to be configured to directly interact with one or more ticket sale and distribution systems 12 via the acquisition software application.

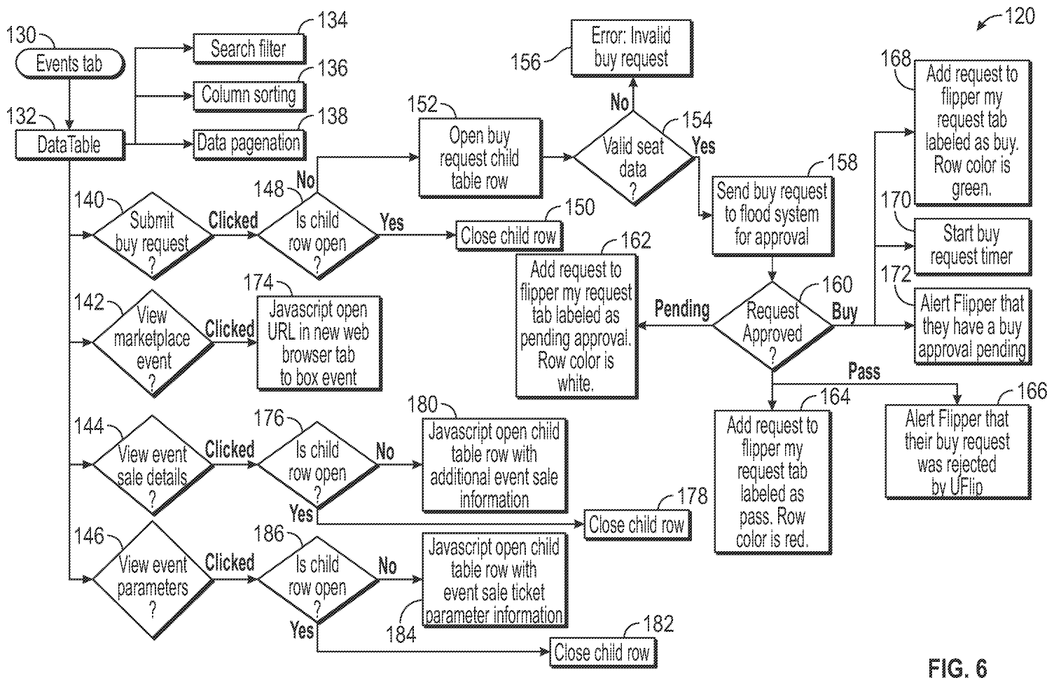

FIGS. 6-10 illustrate a flow chart 120 and associated screen shots 122, 222, 232 and 242 describing processes and use of the event application of the acquisition software application accessed via the events tab 72 in accordance with the present disclosure. Referring to FIGS. 6 and 7, in a step 130, the user may click on the events tab 72 allowing the events application of the acquisition software application to populate a datatable 200 as in step 132 in FIG. 6. The datatable may include event characteristics including, but not limited to, event name 202, event type, sale data 204, ticket sales and distribution systems 12 (i.e., marketplace 206), one or more hyperlinks 208 to third party systems (e.g., hyperlink to one or more ticket sales and distribution systems 12) and/or the like. In some embodiments, the acquisition software application may be configured to allow a user to use a search bar 210 to search by filter as in step 134 in FIG. 6. For example, a user may provide boolean-type search terms to search for event(s), date(s), time(s), ticket sales and distribution systems 12 (i.e., marketplace), and/or the like. In some embodiments, the acquisition software application may be configured to allow for a user to sort columns as in step 136 in FIG. 6. For example, a user may sort columns alphabetically by marketplace, event name or location, or low to high by sale date, event date, time, and/or the like. In some embodiments, the acquisition software application may include client-side data pagenation and/or server-side data pagenation as shown in step 138 of FIG. 6. For example, the user may be able to view separate pages of the datatable 200 in FIG. 7 (e.g., via JavaScript or the like) via server-side data pagenation.

Generally, the events application of the acquisition software application aids in submitting buy requests 140, viewing marketplace events 142, viewing event sale details 144, and viewing event parameters 146 as shown in FIG. 6 and discussed in further detail herein.

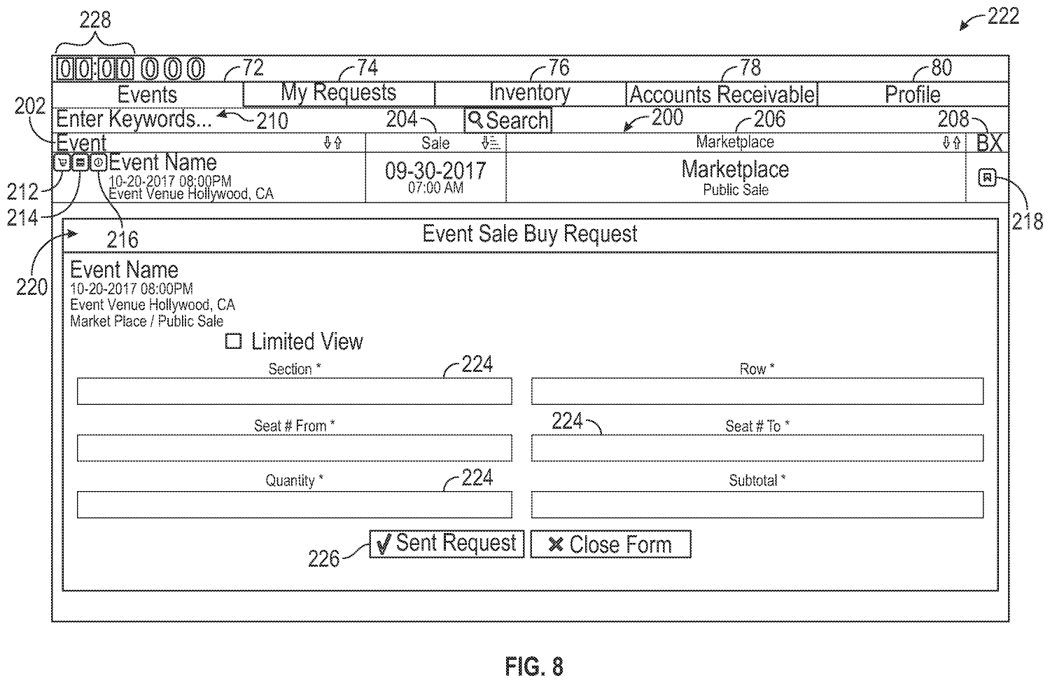

Referring to FIGS. 6 and 7, buy requests 140 may be submitted by a user clicking on a buy icon 212 for a particular event. The buy request 140 informs the database server 22, management system 14, flood system 18, and consumer purchasing system 20 that the user is capable of buying one or more pre-determined and specific tickets for an event. The user may select to buy one or more tickets by selecting the buy icon 212 related to a particular event. In some embodiments, the datatable 200 may use a parent-child data structure wherein data is organized in a tree-like structure wherein each child record has only one parent. In this model, the buy request for a particular event would be considered a child under the parent “event”. As such, if the buy request is already open, by selecting the buy request, the child would close as indicated in steps 148 and 150 in FIG. 6. If the buy request is closed, a buy request child row 220 may be opened as indicated in step 152 and screen shot 222 in FIG. 8.

The buy request child row 220 may provide details regarding the event, date, time, location, ticket sales and distribution system 12, and/or the like. Additionally, the buy request child row 220 may provide one or more status updates. For example, in FIG. 8, the buy request child row 220 provides the status update “Public Sale.”

The buy request child row 220 may also include one or more ticket identifiers 224. Ticket identifiers 224 provide one or more details regarding tickets capable of being purchased by the user and/or flipper system 16 including, but not limited to, section, row, seat location (e.g., seat number), quantity, monetary value, viewing quality of seats, and/or the like. The user and/or flipper system 16 may provide answers to one or more of the ticket identifiers 224 in order to submit the buy request. Once the buy request is submitted via icon 226, the database server 22, management system 14, flood system 18, and/or consumer purchasing system 20 may determine whether the buy request is a valid request as in step 154 in FIG. 6. For example, the database server 22 may determine whether the seats indicated by the buy request are valid seats for the event. If the database server 22 determines the seats for the event are invalid, one or more error messages may be provided to the flipper system 16 as indicated in step 156. If the buy request is determined to be valid, the buy request may be transmitted to the flood system 18 and/or consumer purchasing system 20 for review as indicated by step 158 in FIG. 6.

The flood system 18 and/or consumer purchasing system 20 may review the buy request for tickets to the event and determine whether to buy or on pass (i.e., not buy) the tickets as indicated by step 160 in FIG. 6. If the buy request is pending, the buy request may be added to the My Requests tab 74 and labeled as “pending” as indicated by step 162. If the buy request is rejected, the buy request may be added to the My Requests tab 74 and labeled as “passed” as indicated by step 164 in FIG. 6. Additionally, the user and/or flipper system 16 may be alerted that the buy request was rejected as in step 166. Such alert may be via a pop-up window, messaging system, and/or the like. If the buy request is accepted, the buy request may be added to the My Requests tab 74 and labeled as “buy” as indicated by step 168. Additionally, in some embodiments, a timer 228 may be started with a pre-determined amount of time (e.g., 10 minutes) in which the user and/or flipper system 16 may be allowed to purchase such tickets described in the buy request as indicated in step 170. Additionally, the user and/or flipper system 16 may be alerted (e.g., via pop-up window, messaging system, and/or the like) that the buy request was approved and/or the timer 228 is initiated as indicated in step 172 in FIG. 6.

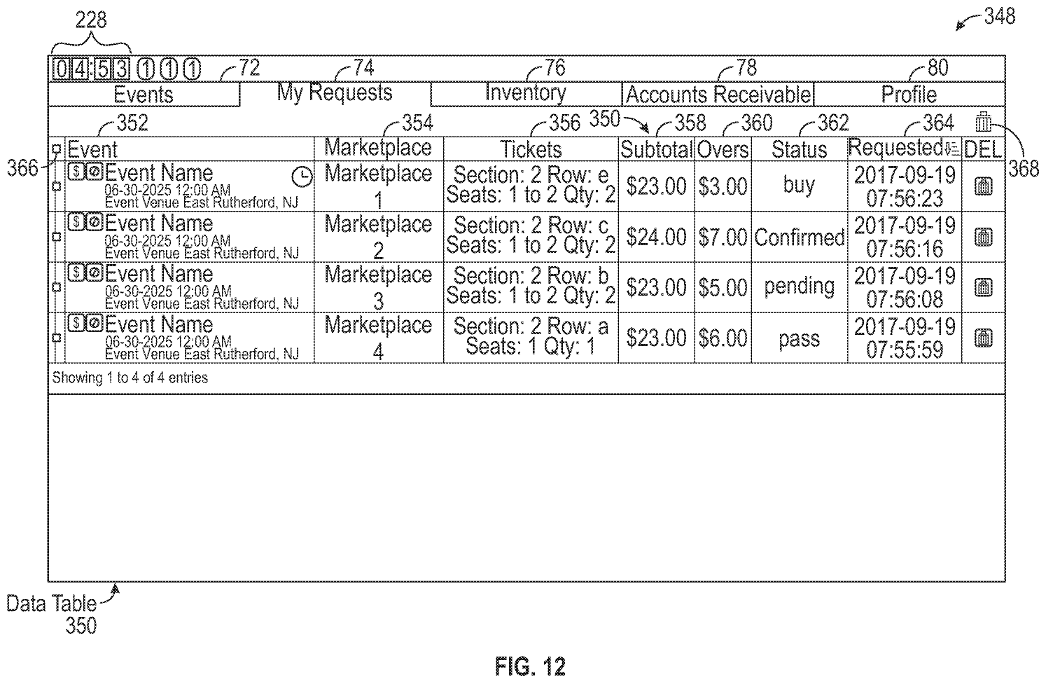

In some embodiments, the datatable 350 in FIG. 12 may use status indicators to illustrate status of a buy request. For example, in some embodiments, the datatable 350 may use color coding to indicate status of each buy request (e.g., row color white is a pending buy request, row color red is a passed on and/or rejected buy request, row color green is an approved buy request, row color yellow means the buy request is under review, and/or the like). Other types of labeling may be used to indicate status of each buy request, such as, for example, wording, numbers, colors, percentages, status bars, and/or the like.

The events application of the acquisition software application may also aid in viewing box office events as indicated in step 142 of FIG. 6. The user may click on the icon 218 shown in FIG. 7 to open one or more uniform resource locators (URLs) or the like as indicated in step 174. The URL may be the web address for the ticket sales and distribution system 12, for example. To that end, the user and/or flipper system 16 may view marketplace event information and/or data via the ticket sales and distribution system 12, for example. In some embodiments, the URL for the ticket sales and distribution system 12 may open in a separate web browser.

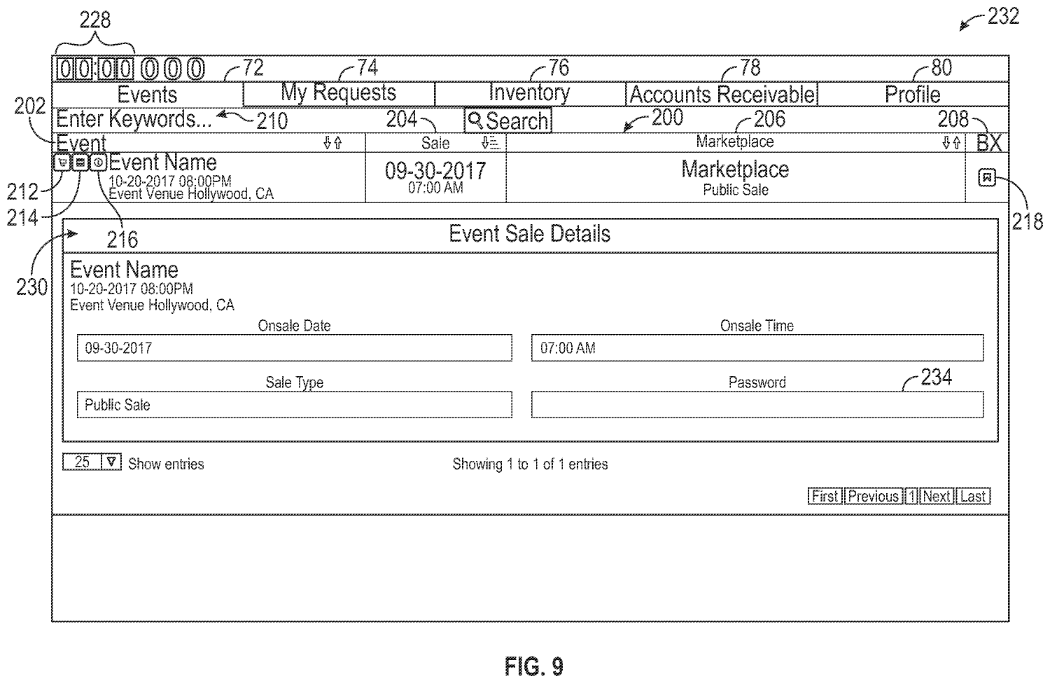

The events application of the acquisition software application may be configured to provide event sale details as indicated by step 144. Similar to the buy request, the datatable 200 may use a parent-child data structure wherein data is organized in a tree-like structure wherein each child record has only one parent. In this model, the event sale details for a particular event would be considered a child under the parent “event”. As such, if the event sale details row is already open, by selecting the event sale details row, the child would close as indicated in steps 176 and 178 in FIG. 6. If the event sale request row is closed, an event sale details row 230 may be opened as indicated in step 180 and screen shot 232 in FIG. 9. The event sale details row 230 may include details related to the particular event including, but not limited to, on-sale data, sale type (e.g., on-going, intermittent, closed, verified buyer sales, and/or the like), on-sale time, and/or the like. Additionally, in some embodiments, the event sale details row 230 may provide one or more identifiers 234 for the user. For example, in FIG. 9, the event sale details row 230 provides at least one identifier 234 for an event password for the ticket sales and distribution system 12 wherein such tickets may be purchased. Additional identifiers 234 may include, but are not limited to, delivery options, minimum quantity, ticket limit, on-sale date, on-sale time, sale type, and/or the like.

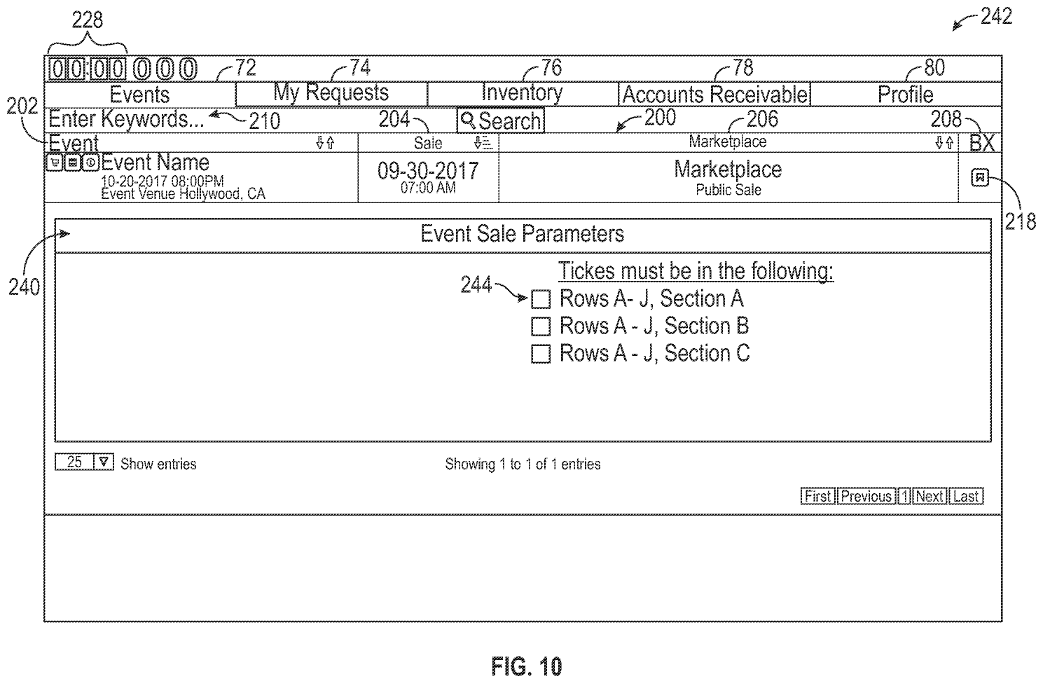

The events application of the acquisition software application may be configured to provide event sale parameters as indicated by step 184. Similar to the buy request and event sale details, the datatable 200 may use a parent-child data structure wherein data is organized in a tree-like structure wherein each child record has only one parent. In this model, the event sale parameters for a particular event would be considered a child under the parent “event”. As such, if the event sale parameters row is already open, by selecting the event sale details row, the child would close as indicated in steps 186 and 182 in FIG. 6. If the event sale parameters row is closed, an event sale parameters row 240 may be opened as indicated in step 184 and screen shot 242 in FIG. 10. The event sale parameters may include one or more directives 244. Directives 244 may provide the user and/or flipper system 16 guidance on ticket reservations and/or purchases. For example, in FIG. 10, the directive 244 includes parameters associated with desired section and rows for reservation and/or purchase of tickets for the event. In some embodiments, the step 154 in FIG. 6 determining validity of the ticket reservation may be determined automatically by comparing the buy request to the one or more event sale parameters. For example, if the buy request includes one or more tickets that vary from the event sale parameters, the buy request may be determined to be invalid automatically without further review via the database server 22, the management system 14, the flood system 18, and/or the consumer purchasing system 20.

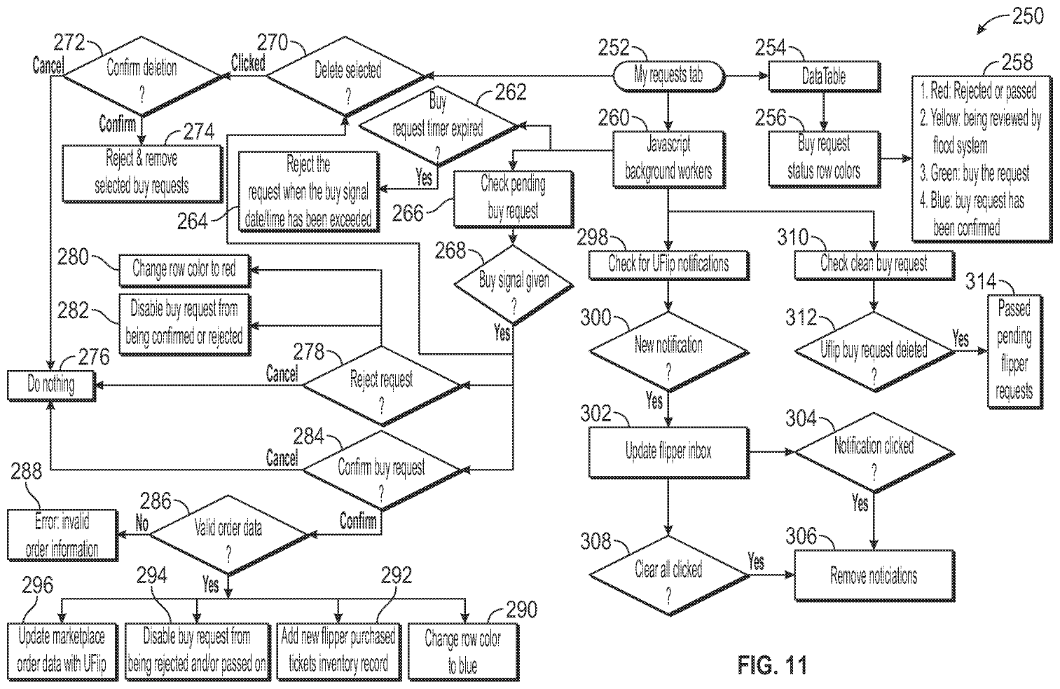

FIGS. 11-13 illustrate a flow chart 250 and associated screen shots detailing the action of a My Requests application of the acquisition software application. The My Requests tab 74 may direct the user to the My Requests application of the acquisition software application as indicated by step 252 in FIG. 11. Generally, the My Requests application aids in presenting a datatable 350 as indicated by step 254. The datatable 350 may generally provide pending buy requests, passed buy requests, rejected buy requests, approved buy requests, confirmed buy requests, and updating notifications from the database server 22, the management system 14, the flood system 18, and/or the consumer purchasing system 20 shown in FIG. 1, updating buy request status, and/or the like as illustrated in the flow chart 250 illustrated in FIG. 11 and discussed in further detail herein.

Referring to FIGS. 11 and 12, the datatable 350 may include one or more buy characteristics including, but not limited to, event information 352, marketplace 354 (i.e., ticket sales and distribution system 12), ticket location 356, ticket subtotal 358, overage 360 (e.g., additional fees to be paid to the flippers), buy request status 362, date and/or time requested 364, and/or the like. The event information 352 may include data related to the event such as name of the event, date, and time of the event, location of the event, and/or the like. The marketplace 354 may be the ticket sales and distribution system 12. In some embodiments, the marketplace 354 may include hypertext configured to direct the user and/or flipper system 16 to the ticket sales and distribution system 12. The ticket location 356 may include details related to the ticket for the event including, but not limited to, section number, row number, quantity of tickets, and/or the like. The ticket subtotal 358 may provide the pre-purchase monetary value of the tickets.

The buy request status 362 may provide information related to the status of the buy request as related to the flood system 18, and/or consumer purchasing system 20. For example, the datatable 350 may generally provide pending buy requests, passed buy requests, rejected buy requests, approved buy requests and confirmed buy requests, as indicated by steps 256 and 258 of the flow chart 250 in FIG. 11. In some embodiments, the status of each buy request may be indicated by color such as, for example, the color red used on a row indicating passed and/or rejected tickets, the color yellow used on a row indicating the buy request is being reviewed by the flood system 18, and/or consumer purchasing system 20, the color green used on a row to indicate the buy request is approved for buying, and the color blue used on a row to indicate that the buy request has been confirmed by the user and/or flipper system 16.

During use of the acquisition software application, one or more background applications may be running via the My Request application. For example, during use of the acquisition software application, the My Request application may query the database server 22, management system 14, flood system 18, and/or consumer purchasing system 20 for status of the timer buy request status, notifications from the database server 22, management system 14, flood system 18, and/or consumer purchasing system 20, and/or the like as indicated by the step 260 in the flow chart 250 illustrated in FIG. 11.

The My Request application may continuously or intermittently query the timer 228 to determine whether the timer 228 in FIG. 12 is expired as indicated by step 262. The timer 228, as indicated previously, may be initiated upon approval of one or more buy requests from the flood system 18 and/or consumer purchasing system 20, for example. If the timer 228 is expired, the status of an approved buy request may be updated to an expired buy request and the flipper system 16 automatically rejects the approved buy request as indicated by step 264. On the flood system 18 and/or the consumer purchasing system 20, the expired buy request may be displayed as expired, and on the flipper system 16 the expired buy request may show up as rejected.

The My Request application may continuously or intermittently query the database server 22, management system 14, flood system 18, and/or consumer purchasing system 20 for updates relating to one or more pending buy requests as indicated in step 266. The My Request application may then determine whether one or more actions related to the update provided for the pending buy request based on whether the pending buy request is passed, approved, or rejected as indicated by step 268.

In a step 270, if the pending buy request is deleted via the user, flipper system 16, the My Request application may provide a confirmation to the user to confirm deletion of the pending buy request as indicated by step 272. For example, the user may select one or more rows via selection icons 366, and then using icon 368 as indicate on the My Request application that such pending buy request may be deleted. If the user confirms deletion of the pending buy request, the My Request application may reject and/or remove one or more pending buy requests as indicated by step 274. If the user does not confirm deletion of the pending buy request, the My Request application may take no action related to the pending buy request as indicated by step 276.

In a step 278, if the pending buy request is rejected by the flood system 18 and/or the consumer purchasing system 20, for example, the My Request application may alter the status of the pending buy request from pending to rejected (e.g., alter color of the row from yellow to red as indicated by step 280. In some embodiments, the My Request application may also disable the buy request from being further confirmed or rejected by the flipper system 16 as indicated by step 282.

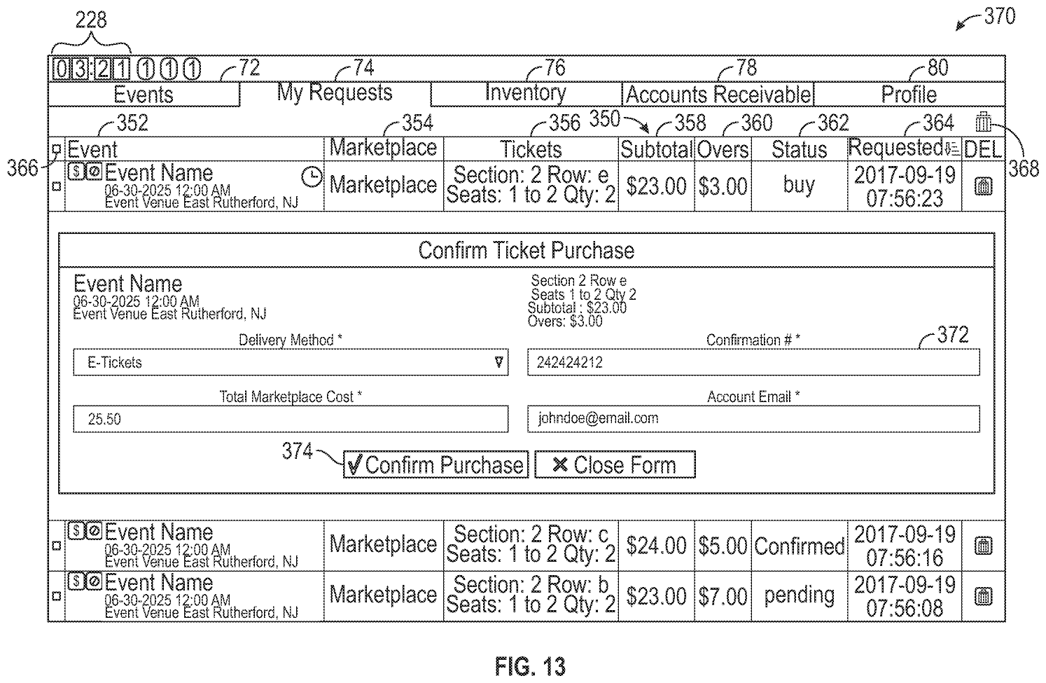

In a step 284, if the pending buy request is approved by the flood system 18 and/or the consumer purchasing system 20, the My Request application may provide for the user to confirm purchase of the tickets as shown in the screen shot 370 in FIG. 13. Confirmation of the purchase of the approved buy request may be made via one or more identifiers 372. The identifiers 372 may include, but are not limited to, delivery method, cost, confirmation or receipt number, account e-mail for the ticket sales and distribution system 12, and/or the like as indicated in FIG. 13. The user may then confirm purchase of the tickets via the icon 374.

In a step 286, the My Request application may determine whether the approved buy request is a valid order subsequent to confirmation of purchase. For example, a user may have an invalid confirmation or receipt number, account e-mail, cost, and/or the like, such that buy request is now invalid. If the approved buy request is an invalid order, the My Request application may provide one or more error messages to the user and/or flipper system 16 indicating the order information is not valid, and/or the like as indicated in step 288. The My Request application may then update the flipper system 16 regarding the validity of the buy request for user correction and/or deletion.

If the approved buy request is determined to be a valid order, approved, and purchased, the approved buy request transitions to a confirmed buy request and the My Request application may update the status of the buy request (e.g., alter color of the row from green to blue as indicated by step 290) and the confirmed buy request may be added to the inventory tab 76 as indicated in step 292. In some embodiments, the My Request application may also disable the confirmed buy request from being further rejected by the flipper system 16 and passed on by the flood system 18 and/or the consumer purchasing system 20 as indicated by step 294. The My Request application may also transmit one or more communications from the flipper system 16 to provide the flood system 18, the database server 22, the management system 14 and/or the consumer purchasing system 20 with updated order data as indicated by step 296.

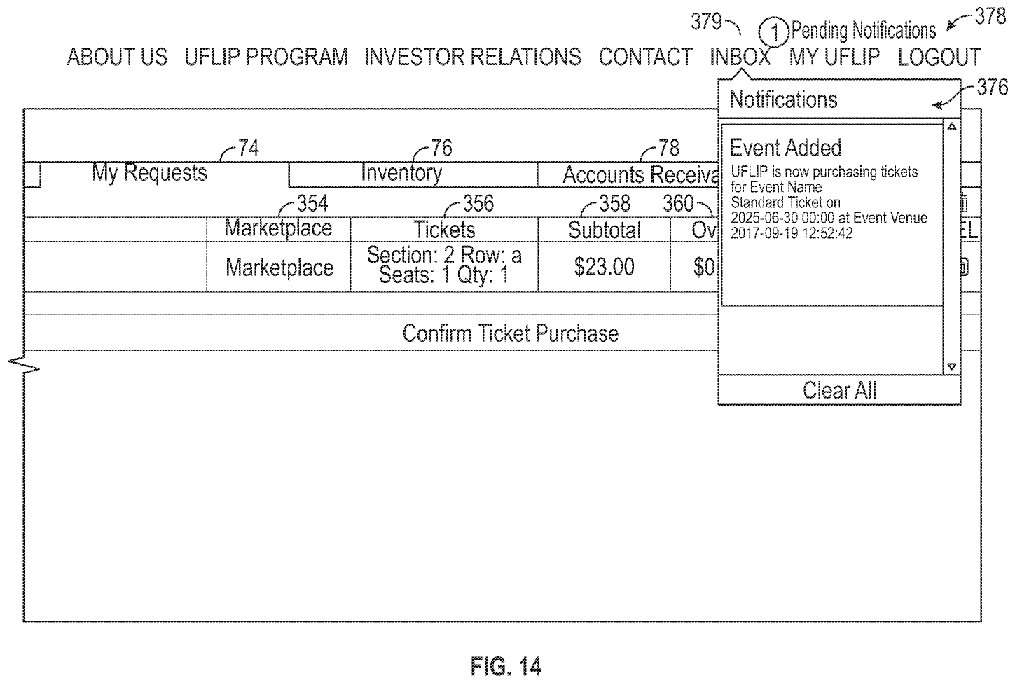

In some embodiments, the My Request application may also query the database server 22, the management system 14, the flood system 18, and/or the consumer purchasing system 20 regarding one or more notifications 376 as indicated by step 298 in FIG. 11 and screen shot 378 in FIG. 14. Notifications 376 may include one or more updates including, but not limited to, new events, updated events, expired events, event parameter information, and/or the like. For example, in FIG. 14, the notification 376 from the management system 14 indicates that a new event for purchasing tickets is now available. If the management system 14, for example, transmits one or more new notifications 376 as indicated by step 300, an inbox 379 may be updated on the flipper system 16 as shown in FIG. 14 and step 302 in FIG. 11. Once the user selects the notification 376 as indicated by step 304, the notification 376 may be deleted as indicated by step 306. Alternatively, the user may select one or more notifications to be deleted as indicated by step 308.

In some embodiments, the My Request application may query the database server 22, management system 14, flood system 18, and/or consumer purchasing system 20 to determine if tickets are still needed for purchase as indicated in step 310 of FIG. 11. If the database server 22, management system 14, flood system 18 and/or consumer purchasing system 20 indicate that all buy requests have been deleted as indicated in step 312, the My Request application may pass on all pending buy requests as indicated by step 314.

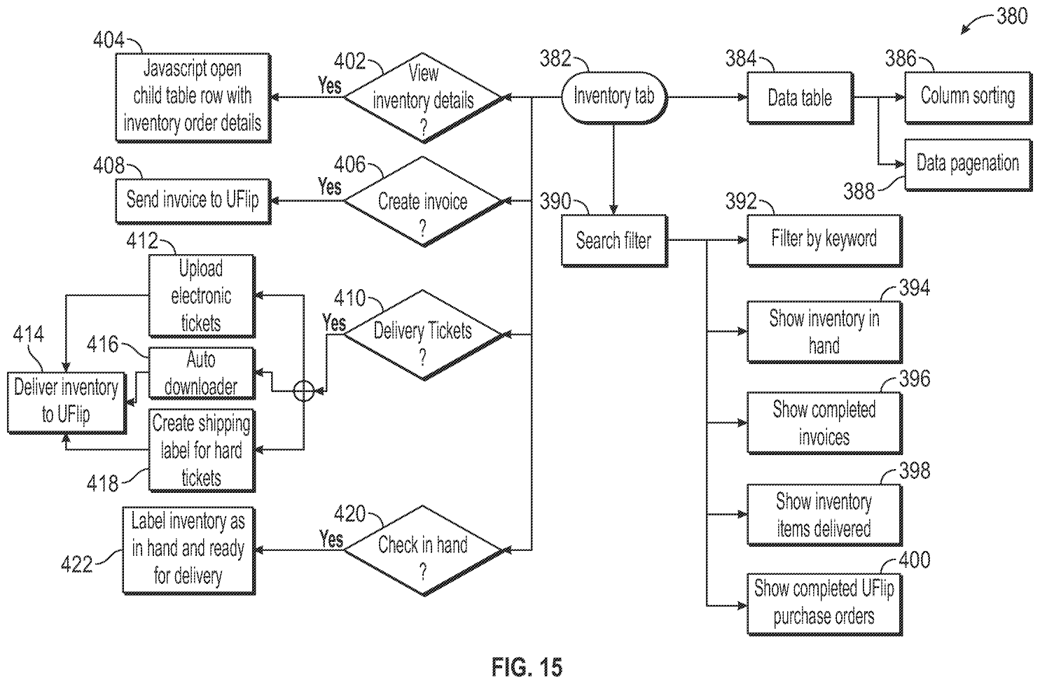

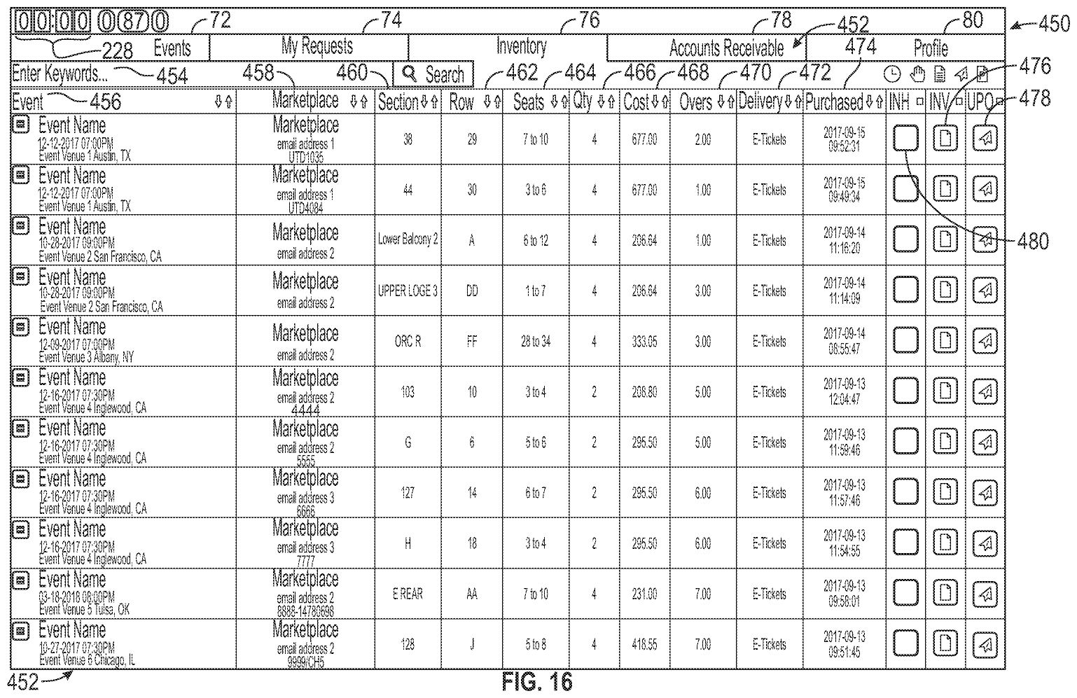

FIGS. 15-16 illustrate a flow chart 380 and associated screen shot 450 detailing the action of an inventory application of the acquisition software application. The inventory tab 76 may direct the user to the inventory application as indicated by step 382 in FIG. 15. The inventory application may populate a datatable 452 shown in FIG. 16 and indicated by step 384. Similar to the datatable 200 in FIG. 7, the datatable 452 may be configured to provide column sorting as in step 386, data pagenation as in step 388, and other like features associated with datatables. Additionally, the datatable 452 may include a search filter 454 as indicated by step 390. In addition to providing keyword searching and/or filter in step 392, the search filter 454 may also provide viewing of inventory in real time as in step 394, provide viewing of completed invoices as in step 396, provide viewing of delivery status for inventory items in step 398, provide viewing of completed purchase orders in step 400, and/or the like.

The datatable 452 may include one or more inventory characteristics including, but not limited to, event 456, marketplace 458 (e.g., ticket sales and distribution system 12), section number 460, row number 462, seat number 464, quantity of tickets 466, total cost of tickets 468, overage for tickets 470, delivery method for tickets 472 (e.g., shipping, electronic delivery, will call, and/or the like), purchase time and/or date 474, and/or the like.

Additionally, in some embodiments, the inventory application may provide further viewing of additional inventory details as in step 402. For example, a child table and/or row may be created via the inventory application, with the child table and/or row providing additional inventory details as needed as indicated in step 404.

In some embodiments, the inventory application may provide for creation of one or more invoices by the flipper to transmit to the database server 22, management system 14, and/or consumer purchasing system 20 as indicated in step 406. The flipper may select an invoice icon 476 as shown in FIG. 16. In some embodiments, the inventory application may populate a preset inventory template using data stored on the flipper system 16 and/or database server 22 related to the inventory of tickets obtained by the user. In step 408, the invoice may be transmitted to the database server 22, management system 14, and/or consumer purchasing system 20. In some embodiments, the acquisition software platform may distribute funds (e.g., physical check, allocation through private transfer, allocation through third party transfer such as PayPal or Venmo) to the user associated with the flipper system 16.

In some embodiments, the user may determine delivery of the tickets as indicated by step 410 by selection of one or more processes of delivery. In one example, the user may select uploading one or more electronic tickets to the flipper system 16 as indicated by step 412. The ticket may then be delivered to the database server 22, management system 14, and/or consumer purchasing system 20 as indicated by step 414. In some embodiments, the tickets may be automatically downloaded by the database server 22, management system 14, and/or flipper system 16 using, for example, the user's password and/or confirmation number for the ticket sales and distribution system 12 as indicated by step 416. In some embodiments, the user may create a shipping label for the tickets by selecting the shipping icon 478 in FIG. 16 and as indicated by step 418 in FIG. 15. The tickets may then be shipped to a physical location for inventory processing. The inventory status may then be updated in the database server 22, management system 14, flipper system 16, and/or consumer purchasing system 20.

In some embodiments, the user may indicate to the inventory application that the tickets are in physical presence of the flipper, accessible at the present time, or under the user's control or authority by selecting an in-hand icon 480 as indicated by step 420. The inventory application may then update inventory status as in hand and ready for delivery as indicated by step 422.

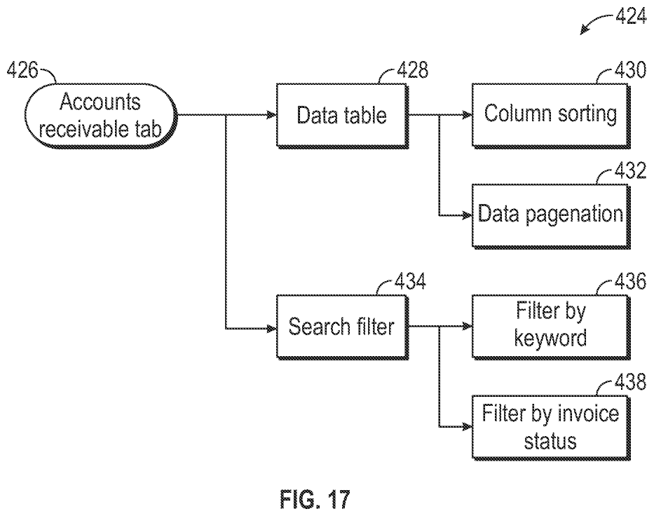

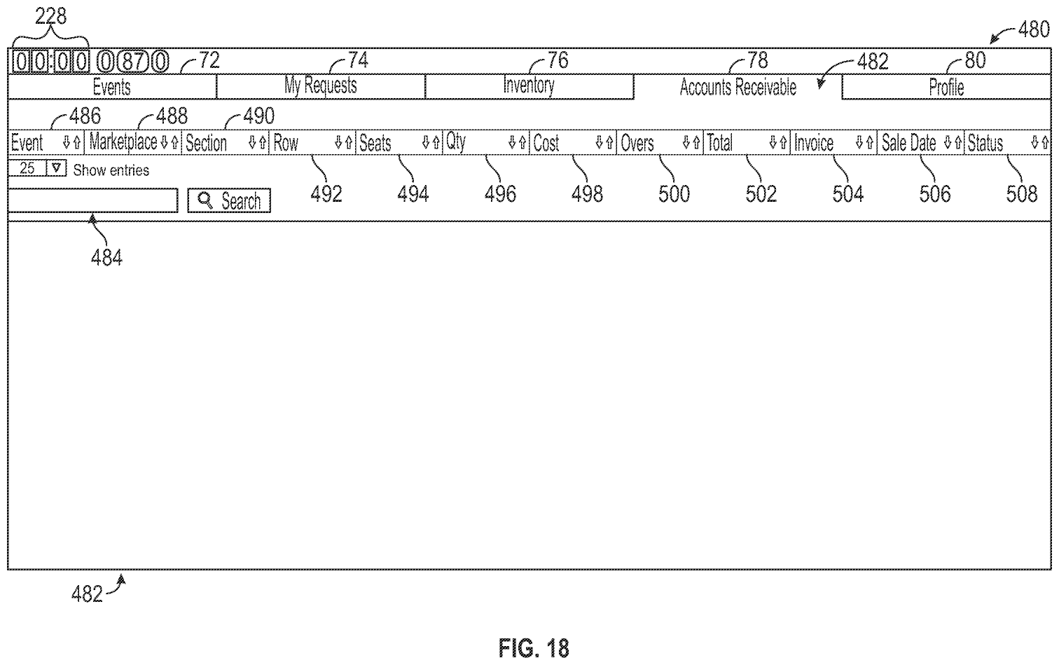

FIGS. 17-18 illustrate a flow chart 424 and associated screen shot 480 detailing action of an accounts receivable application of the acquisition software application. Generally, the accounts receivable application details all paid invoices provided by user and/or flipper system 16 to the database server 22, management system 14, and/or consumer purchasing system 20 and may be accessed by the accounts receivable tab 78 as indicated in step 426. The accounts receivable application may provide for a datatable 482 as indicated in step 428. Similar to the datatable 200 in FIG. 7, the datatable 482 may be configured to provide column sorting as in step 430, data pagenation as in step 432, and other like features associated with datatables. Additionally, the datatable 482 may include a search filter 484 and indicated by step 434. In addition to providing keyword searching and/or filter in a step 436, the search filter 484 may also provide viewing of inventory status in real time as in step 438, and/or the like.

The datatable 482 may include one or more account characteristics including, but not limited to, event 486, marketplace 488 (e.g., ticket sales and distribution system 12), section number 490, row number 492, seat number 494, quantity of tickets 496, total cost of tickets 498, overage for tickets 500, total cost of tickets 502, invoice number 504, sale date of tickets 506, invoice status 508, and/or the like.

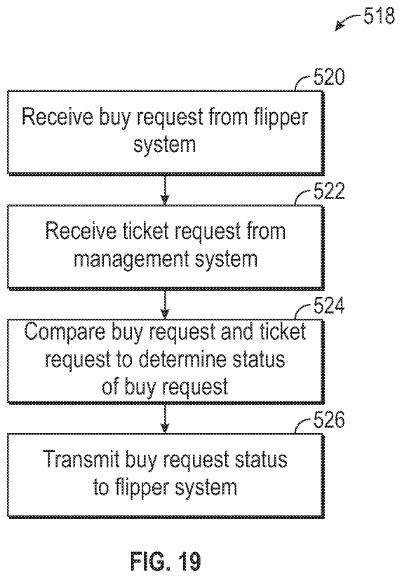

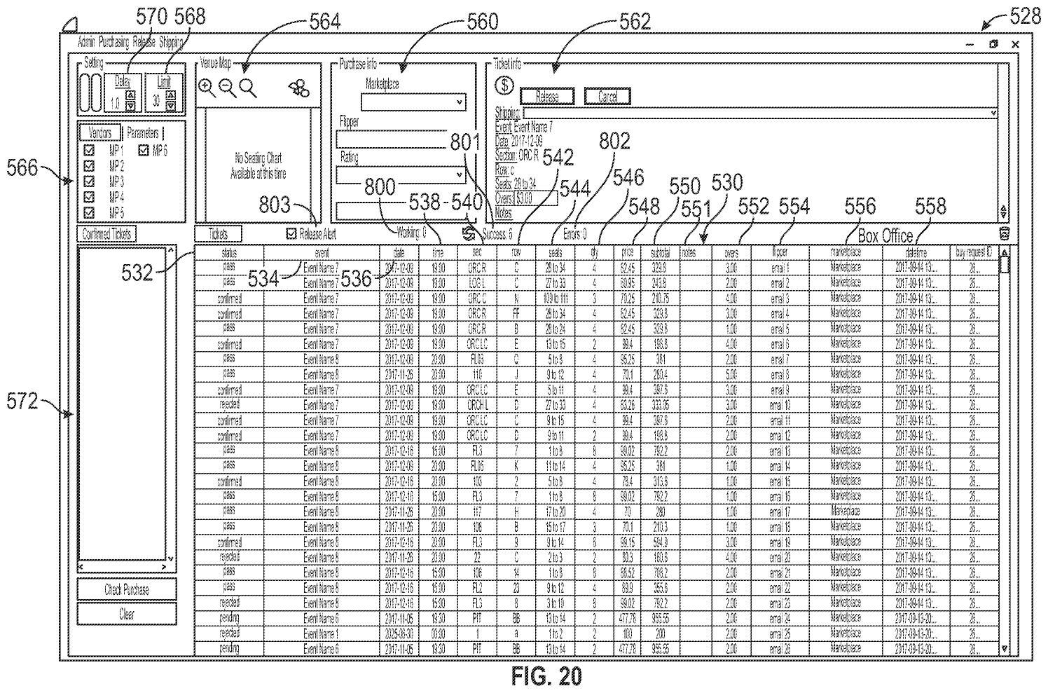

FIGS. 19-20 illustrate an exemplary embodiment of the acquisition software application for the flood system 18 of the acquisition system 10. The acquisition software application for the flood system 18 may be downloaded on one or more devices. Alternatively, the acquisition software application for the flood system 18 may be accessed from the database server 22 via the network 24. In some embodiments, the flood system 18 may be within the database server 22.

Referring to FIG. 19, illustrated therein is a flow chart 518 of an exemplary process for the acquisition software application for the flood system 18. In a step 520, the flood system 18 may receive one or more buy requests from the flipper system 16 as described in detail herein. In a step 522, the flood system 18 may receive one or more ticket requests from the management system 14. In a step 524, the flood system 18 may compare the buy request and the ticket request to determine status of the buy request (i.e., approve or reject). In a step 526, the flood system 18 may transmit the updated status of the buy request to the flipper system 16. In some embodiments, the flood system 18 may performed each of the steps in FIG. 19 automatically without human intervention and within a predetermined amount of time.

FIG. 20 illustrates an exemplary screen shot 528 of the application for the flood system 18. The acquisition software application for the flood system 18 may provide a datatable 530. The datatable 530 may include one or more flood characteristics including, but not limited to, ticket status 532, event 534, event date 536, event time 538, section number 540, row number 542, seat number 544, ticket quantity 546, ticket cost 548, purchase subtotal 550, purchase notes 551 or overage 552, flipper name 554, marketplace 556, user submission date 558, and/or the like. Additionally, the acquisition software application for the flood system 18 may provide for detailed purchase data 560, detailed ticket data 562, and/or detailed venue data 564 as illustrated in FIG. 20. In some embodiments, the acquisition software for the flood system 18 may provide a targeted searching function 566. The targeted searching function may allow for filtering based on pre-determined criteria (e.g., specific ticket sales and distribution systems 12 such as LiveNation, StubHub, and/or the like). In some embodiments, the acquisition software application for the flood system 18 may allow for the amount of buy requests returned in one query 568 and/or delay time in between queries 570. Additionally, a real time status indicator section 572 may provide updates on tickets purchases confirmed by flipper systems 16.

The acquisition platforms systems and methods disclosed herein are well adapted to carry out the objects and to attain the advantages mentioned herein, as well as those inherent in the invention, to solve problems including problems inherent in the software arts. While exemplary embodiments of the inventive concepts have been described for purposes of this disclosure, it will be understood that numerous changes may be made which will readily suggest themselves to those skilled in the art and which are accomplished within the spirit of the inventive concepts disclosed and claimed herein.

1. An automated method performed by at least one processor running computer executable instructions stored on at least one non-transitory computer readable medium, comprising:
transmit at least one-ticket request for an event to at least one flipper system, the ticket request indicating a desired quantity, and associated ticket sales and distribution system, the ticket request transmitted prior to purchase from the associated ticket sales and distribution system;
receive at least one communication from the flipper system of a buy request for at least one ticket from the ticket request, the flipper system having the at least one ticket reserved via the associated ticket sales and distribution system, the at least one ticket having a location and price, the buy request received prior to purchase from the associated ticket sales and distribution system;
update status of the buy request for the at least one ticket to the event based on comparisons of the location and price of the at least one ticket to the desired location, desired price and desired quantity of the ticket request;
transmit the updated status of the buy request to the flipper system; and,
receive confirmation from the at least one flipper system of ticket purchase from the associated ticket sales and distribution system related to the buy request.

2. The automated method of claim 1, wherein the updated status of the buy request is at least one of an approved buy request for at least one ticket or a denied buy request for at least one ticket.

3. The automated method of claim 1, further comprising transmitting an updated ticket request to the at least one flipper system based on the updated status of the buy request.

4. The automated method of claim 1, further comprising activating a timer for a pre-determined amount of time upon alteration of the status of the buy request.

5. The automated method of claim 4, updating the status of the buy request upon expiration of the pre-determined amount of time.

6. The automated method of claim 1, further comprising:
determining funds to be distributed to the flipper system based on purchase of tickets; and,
transmitting funds to the flipper system.

7. The automated method of claim 1, further comprising:
transmitting at least one notification to the at least one flipper system, the at least one notification having at least one update of the ticket request.

8. The automated method of claim 1, further comprising:
transmitting at least one notification to the at least one flipper system, the at least one notification having at least one update of the buy request.

9. The automated method of claim 1, further comprising:
receiving a confirmation number for the buy request from the flipper system; and
obtaining at least one ticket via the ticket sales and distribution system using the confirmation number.

10. The automated method of claim 1, further comprising receiving at least one ticket via electronic delivery from the flipper system.

11. The automated method of claim 1, further comprising providing at least one shipping label to the flipper system for delivery of at least one ticket.

12. One or more non-transitory computer readable medium storing a set of computer executable instructions for running on one or more processors that when executed cause the processors to:
receive a ticket request from a management system, the ticket request indicating a desired quantity of tickets for a particular event, the ticket request received prior to purchase from an associated ticket sales and distribution system;
receive a pending buy request from a flipper system, the pending buy request indicating a quantity of reserved tickets for the particular event, the reserved tickets having a location and a purchase price, the pending buy request received prior to purchase from the associated ticket sales and distribution system;
updating status of the pending buy request by comparing the ticket request with the pending buy request; and,
transmitting the updated status of the pending buy request to the flipper system.

13. The one or more non-transitory computer readable medium storing the set of computer executable instructions for running on one or more processors of claim 12, wherein the pending buy request includes at least one ticket reserved on a ticket sales and distribution system via the flipper system.

14. The one or more non-transitory computer readable medium storing the set of computer executable instructions for running on one or more processors of claim 13, wherein the updated status of the pending buy request is an approved buy request.

15. The one or more non-transitory computer readable medium storing the set of computer executable instructions for running on one or more processors of claim 14, further comprising receiving a confirmation number from the flipper system for the approved buy request and obtaining at least one ticket from the ticket sales and distribution system using the confirmation number for the approved buy request.

16. The one or more non-transitory computer readable medium storing the set of computer executable instructions for running on one or more processors of claim 14, further comprising receiving an e-mail address associated with the ticket sales and distribution system from the flipper system for the approved buy request and obtaining at least one ticket from the ticket sales and distribution system using the e-mail address via the ticket sales and distribution system.

17. An automated system, comprising:
at least one processor executing an acquisition software application receiving:
at least one buy request from a flipper system, the buy request associated with at least one ticket for an event from a ticket sales and distribution system, the buy request received prior to purchase from the ticket sales and distribution system; and,
at least one of a confirmation number or e-mail address associated with buy request and the ticket sales and distribution system;
wherein the acquisition software application approves the at least one buy request and uses the at least one of the confirmation number and e-mail address to access the ticket sales and distribution system and obtain the at least one ticket for the event.

18. The automated system of claim 17, wherein the at least one processor executing an acquisition software application further receives at least one invoice associated with the buy request.

19. The automated system of claim 18, wherein the acquisition software application approves the invoice and distributes monetary funds to a flipper associated with the flipper system.

20. The automated system of claim 19, wherein distribution of funds to the flipper includes at least one of printing a physical check to be mailed to a flipper associated with the flipper system, and electronic funds transfer.
